(19) United States
(12) Patent Application Publication
(10) Pub. No.: US 2016/0168953 A1
(43) Pub. Date: Jun. 16, 2016

(54) PROGNOSIS AND DIAGNOSIS SYSTEM FOR A PUMP USED IN HYDRAULIC FRACTURING

(71) Applicant: Caterpillar Inc., Peoria, IL (US)

(72) Inventors: Yanchai Zhang, Dunlap, IL (US); Evan Earl Jacobson, Edwards, IL (US); Koti Ratnam Padarthy, Edwards, IL (US); Venkata Bhagavathi Dandibhotla, Peoria, IL (US)

(73) Assignee: Caterpillar Inc., Peoria, IL (US)

(21) Appl. No.: 14/571,782

(22) Filed: Dec. 16, 2014

(51) Int. Cl. E21B 41/00; G01M 99/00; E21B 43/26

(52) U.S. Cl. CPC E21B 41/00; E21B 43/26; G01M 99/00

(57) ABSTRACT

A prognosis and diagnosis system for a pump includes a reference dataset, a historical dataset, a data acquisition engine (DAE), and a comparison engine. The reference dataset includes theoretical values obtained for at least one performance parameter pertaining to the pump. The historical dataset includes data values for the at least one performance parameter based on historical performance of the pump when the frac rig pump was operating under healthy and normal operating conditions. The DAE is configured to obtain real-time values for the at least one performance parameter that are measured during a current operating condition of the pump. The comparison engine is configured to selectively output a mode of failure based upon a comparison between the real-time values and at least one of the theoretical values from the reference dataset and the data values from the historical dataset.

### TECHNICAL FIELD

The present disclosure relates to a prognosis and diagnosis system. More particularly, the present disclosure relates to a prognosis and diagnosis system for a pump used in a hydraulic fracturing or ‘fracking’ operation.

### BACKGROUND

Pumps that are used in hydraulic fracturing or ‘fracking’ operations are configured to pressurize and transfer a fracturing fluid into a downhole wellbore for creating cracks in deep-rock formations located under the earth's surface. Typically, these pumps include several components that may be subject to high working pressures. An overall performance of the pump may depend on the health of such components. In order to maintain a smooth working of the pump, a health and performance of the components therein may be monitored in a timely manner. For reference, U.S. Pat. No. 7,689,368 discloses a system for early detection of component failure in a hydraulic system.

### SUMMARY OF THE DISCLOSURE

In one aspect of the present disclosure, a prognosis and diagnosis system for a pump includes a reference dataset, a historical dataset, a data acquisition engine (DAE), and a comparison engine. The reference dataset includes theoretical values obtained for at least one performance parameter pertaining to the pump. The historical dataset includes data values for the at least one performance parameter based on historical performance of the pump when the frac rig pump was operating under healthy and normal operating conditions. The DAE is configured to obtain real-time values for the at least one performance parameter that are measured during a current operating condition of the pump. The comparison engine is disposed in communication with the reference dataset, the historical dataset, and the data acquisition system. The comparison engine is configured to selectively output a mode of failure based upon a comparison between the real-time values and at least one of the theoretical values from the reference dataset and the data values from the historical dataset.

In another aspect of the present disclosure, a method for monitoring health of a pump includes obtaining theoretical values for at least one performance parameter pertaining to the pump. The method further includes obtaining data values for the at least one performance parameter based on historical performance of the pump when the pump is healthy and working under normal operating conditions. The method further includes obtaining real-time values for the at least one performance parameter during a current operating condition of the pump. The method further includes comparing the real-time values with at least one of the theoretical values and the data values from the historical performance of the pump. The method further includes selectively outputting a mode of failure for the pump based upon the comparison between the real-time values and at least one of the theoretical values, and the data values based on historical performance of the pump.

In yet another aspect of the present disclosure, a non-transitory computer-readable medium is provided. The non-transitory computer-readable medium has sequences of instruction stored thereon, the sequences of instruction including instruction which when executed by a computer-based system for monitoring health of a pump, causes the computer-based system to obtain theoretical values for at least one performance parameter pertaining to the pump; obtain data values for the at least one performance parameter based on historical performance of the pump when the pump is healthy and working under normal operating conditions; obtain real-time values for the at least one performance parameter during a current operating condition of the pump; compare the real-time values with at least one of the theoretical values and the data values from the historical performance of the pump; and selectively output a mode of failure for the pump based upon the comparison between the real-time values and at least one of the theoretical values, and the data values based on historical performance of the pump.

Other features and aspects of this disclosure will be apparent from the following description and the accompanying drawings.

### BRIEF DESCRIPTION OF THE DRAWINGS

FIG. 1 is a diagrammatic illustration of an exemplary pump employing a prognostics and diagnostics system, in accordance with an embodiment of the present disclosure;

FIG. 2 is a diagrammatic illustration of an exemplary low-level process pursuant to embodiments of the present disclosure;

FIG. 3 is a block diagram of an exemplary computer system, according to an embodiment of the present disclosure; and

FIG. 4 is a flowchart illustrating a method of monitoring performance of a pump, in accordance with an embodiment of the present disclosure.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the user operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to system architecture, block diagrams and flowchart illustrations of methods, and processes according to various aspects of the disclosure. It will be understood that each functional block of the block diagrams, screenshots and the flowchart illustrations, and combinations of functional blocks in the block diagrams, screenshots and flowchart illustrations, respectively, can be implemented by computer program instructions.

These computer program instructions may be loaded onto a general purpose computer, special purpose computer, or other programmable data processing apparatus to produce the disclosed system, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory perform functions consistent with the present disclosure including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The systems, methods and processes disclosed in conjunction with various embodiments of the present disclosure are embodied in systems, modules, and methods for monitoring a health of a pump that is used in a hydraulic fracturing or ‘fracking’ operation. Specific nomenclature used herein is merely exemplary and only used for descriptive purposes. Hence, such nomenclature must not be construed as being limiting of the scope of the present disclosure.

The present disclosure is now described in more detail herein in terms of the disclosed exemplary embodiments of system, processes and methods. This is for convenience only and is not intended to limit the application of the present disclosure. In fact, after reading the following description, it will be apparent to one skilled in the relevant art(s) how to implement the following disclosure in alternative embodiments.

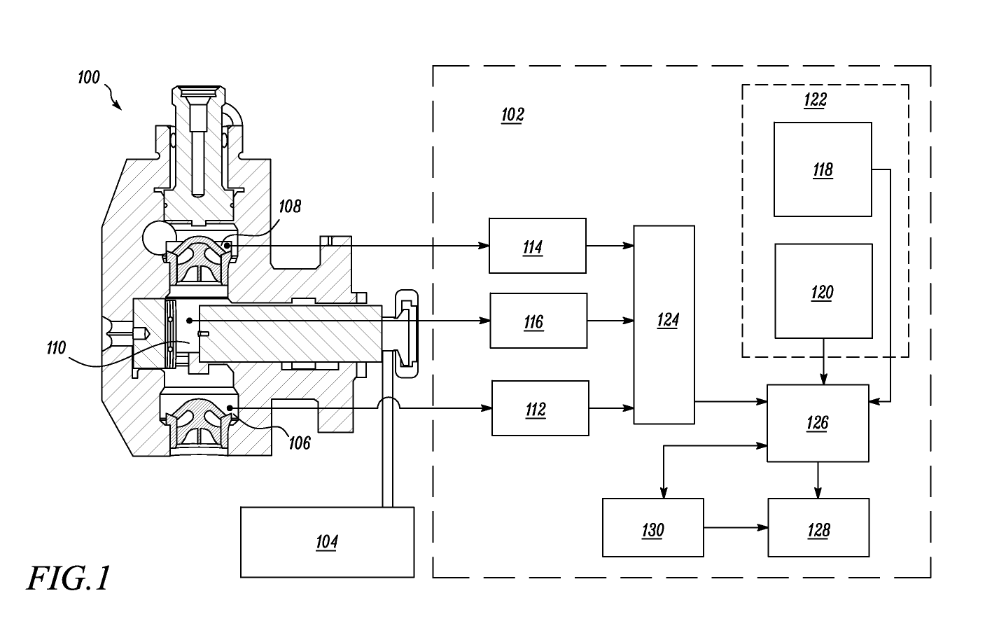

FIG. 1 shows a diagrammatic illustration of an exemplary pump that can be used in a hydraulic fracturing or ‘fracking’ operation, hereinafter referred to as “pump 100”. As shown, the pump 100 employs a prognostics and diagnostics system 102 in accordance with an embodiment of the present disclosure. The pump 100 of the present disclosure may be driven by a suitable power source 104. The power source 104, disclosed herein, may include but is not limited to, engines, gas turbine engines, generator sets, and other types of power sources known to one commonly skilled in the art.

The pump 100 includes a suction manifold 106, a discharge manifold 108, and multiple cylinders 110 located between the suction manifold 106 and the discharge manifold 108 (only one cylinder 110 visible in the cross-sectional view of the pump 100 of FIG. 1).

The suction manifold 106 may be configured to receive a fracking fluid that is mixed at a blender (not shown). The cylinders 110 are provided with movable components therein, for e.g., reciprocating pistons 111, that is configured to pressurize the fracking fluid during operation. The discharge manifold 108 of the pump 100 is configured to output pressurized fracking fluid therefrom into a wellbore for fracturing deep-rock formations (not shown) located under the earth's surface (not shown).

As shown in FIG. 1, the pump 100 may be coupled with a prognosis and diagnosis system 102, hereinafter simply referred to as ‘the system’ and designated with the same reference numeral ‘102’. The system 102 may be provided with a first pressure sensor 112, a second pressure sensor 114, and multiple third pressure sensors 116. However, only one third pressure sensor 116 is shown to correspond with the cross-sectional view of pump 100 in the illustrated embodiment of FIG. 1.

The first pressure sensor 112 may be associated with the suction manifold 106 of the pump 100 and configured to output a pressure value associated with the suction manifold 106. The second pressure sensor 114 may be associated with the discharge manifold 108 of the pump 100 and configured to output a pressure value associated with the discharge manifold 108. Each of the third pressure sensors 116 may be associated with at least one cylinder 110 of the pump 100 so that each of the third pressure sensors 116 are configured to output a pressure value associated with a corresponding cylinder 110 of the pump 100.

With continued reference to FIG. 1, the system 102 includes a reference dataset 118, and a historical dataset 120. In an embodiment, the reference dataset 118 and the historical dataset 120 may be implemented on a memory device 122, which will be explained in greater detail later herein. The reference dataset 118 includes theoretical values obtained for at least one performance parameter pertaining to the pump 100. In an embodiment, the at least one performance parameter may be suction pressure of the pump 100. In another embodiment, the at least one performance parameter may be discharge pressure of the pump 100. In yet another embodiment, the at least one performance parameter may be an in-cylinder pressure of the pump 100. In an alternative embodiment, the at least one performance parameter may be a torque of the pump 100.

Moreover, the theoretical values disclosed herein for the at least one performance parameter may be empirically calculated for the pump 100. However, the theoretical values may optionally be computed from statistical models, simulation models, or experimental test data pertaining to previous trial runs of the pump 100. Such computations may employ formulae, algorithms, or routines that are commonly known to one skilled in the art without deviating from the spirit of the present disclosure.

The historical dataset 120 includes data values for the at least one performance parameter based on historical performance of the pump 100. Moreover, the data values in the historical dataset 120 may be obtained from the first, second, and third pressure sensors 112, 114, and 116 when the pump 100 was operating under healthy and normal operating conditions. The terms “healthy and normal operating conditions” for the pump 100 may be regarded when components of the pump 100 have undergone no deterioration in performance and when the pump 100 is operating under standard load conditions.

As shown in FIG. 1, the system 102 further includes a data acquisition engine (DAE) 124. The DAE 124 is configured to obtain real-time values for the at least one performance parameter, the real-time values being measured during a current operating condition of the pump 100. The terms “current operating condition” for the pump 100 may be regarded as an operating condition that is different from when the pump is operating in the healthy and normal operating conditions. For example, the “current operating conditions” may refer to an operating condition of the pump when components of the pump have undergone some deterioration, or when the pump is operating under load conditions different from that of standard load conditions. As such, the DAE 124 is in communication with the first, second, and third pressure sensors 112, 114, and 116 and may obtain on a real-time basis, the current pressure values that are associated with the suction manifold 106, the discharge manifold 108, and the cylinders 110 of the pump 100.

With continued reference to FIG. 1, the system 102 further includes a comparison engine 126 disposed in communication with the reference dataset 118, the historical dataset 120, and the DAE 124. The comparison engine 126 is configured to selectively output a mode of failure based upon a comparison between the real-time values and at least one of the theoretical values from the reference dataset 118 and the data values from the historical dataset 120. Additionally, the comparison engine 126 may be further configured to determine service life before failure of the pump 100. The comparison engine 126 may be configured with suitable algorithms, programs, and/or routines that may be employed to determine the service life of the pump 100 before failure.

As shown in FIG. 1, the system 102 further includes a display device 128 disposed in communication with the comparison engine 126. The display device 128 is configured to display the failure mode output from the comparison engine 126, and the service life remaining before failure of the pump 100. Explanation to the display device 128 will be made in greater detail later herein.

The system 102 may further include a controller 130 disposed in communication with the comparison engine 126 and the display device 128. The controller 130 may be configured to modulate an operation of the pump 100 based on the comparison between the real-time values with at least one of the theoretical values from the reference dataset 118 and the data values from the historical dataset 120. For example, upon comparison between the real-time values with at least one of the theoretical values from the reference dataset 118 and the data values from the historical dataset 120, the controller may modulate i.e., increase or decrease, an operating speed of the pump 100.

The controller 130 disclosed herein may embody a single microprocessor or multiple microprocessors that include components for controlling operations of the pump 100 based on inputs from the comparison engine 126 and/or inputs from an operator and based on sensed or other known operational parameters. Numerous commercially available microprocessors can be configured to perform the functions of the controller 130 disclosed herein. It should be appreciated that the controller 130 could readily be embodied in a general machine microprocessor capable of controlling numerous machine functions. The controller 130 may include a memory, a secondary storage device, a processor, and any other components for running an application. Various other circuits may be associated with the controller 130 such as power supply circuitry, signal conditioning circuitry, solenoid driver circuitry, and other types of circuitry. Various routines, algorithms, and/or programs can be programmed within the controller 130 for execution thereof to modulate an operation of the pump 100 based on the comparison between the real-time values with at least one of the theoretical values from the reference dataset 118 and the data values from the historical dataset 120.

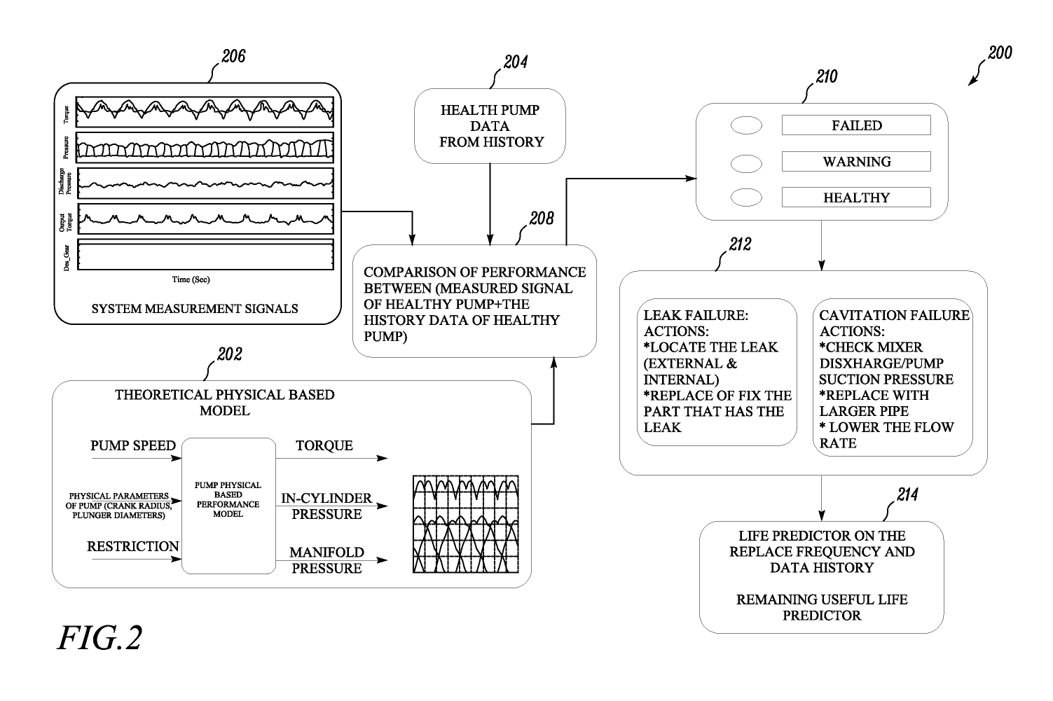

Referring now to FIG. 2, an exemplary process 200 pursuant to embodiments of the present disclosure is outlined. It may be noted that the process 200 illustrated in FIG. 2 is rendered to merely aid the reader's understanding of the present disclosure and hence, is not to be construed as limiting of the present disclosure.

Referring to the illustrated embodiment of FIG. 2, the process 200 includes function blocks 202 through 214. The order or sequence of the function blocks is merely exemplary in nature and hence, non-limiting of this disclosure. It may be noted that a sequence of the function blocks 202 through 214 may be re-ordered or re-arranged without deviating from the spirit of the present disclosure.

At block 202, the theoretical values of the at least one parameter may be determined for the associated pump 100. In the illustrated embodiment of FIG. 2, more than one performance parameter is shown to be computed for the associated pump 100. For example, pump speed, restriction, and/or other physical parameters of the pump 100 may be input into a pump physical based performance model to obtain a torque, an in-cylinder pressure, a suction manifold pressure, and a discharge manifold pressure associated with the pump 100. Moreover, various performance parameters disclosed herein may be computed individually and/or independently of each other without deviating from the spirit of the present disclosure.

At block 204, historical data pertaining to the pump 100 may be available vis-à-vis the historical dataset 120 (See FIG. 1). Moreover, at block 206, real-time measured pressure values may be available from the first, second, and third pressure sensors 112, 114, and 116 (Refer to FIG. 1). As shown in function block 208 from FIG. 2, the real-time measured pressure values may be compared with at least one of the historical data, and the theoretical values associated with the pump 100.

Upon comparison at the function block 208, the process 200 proceeds to function block 210 where indications for representing different levels of failure may be used to indicate the status or health of components in the pump 100. For example, in the illustrated embodiment of FIG. 2, three indicators are shown for distinctly indicating failed, warning (for future failure), and healthy status of the pump 100.

In the illustrated embodiment of FIG. 2, the indications may be rendered via a visual based indication device (not shown), such as, but not limited to, light emitting diodes (LED). Although a visual based indication has been disclosed herein, one of ordinary skill in the art may contemplate other devices for producing indications. For example, audio based indication's may be used in lieu of the visual based indications disclosed in the embodiment of FIG. 2. Therefore, it is to be noted that a type or nature of the indication is merely exemplary in nature and non-limiting of this disclosure. Any type or nature of indication device may be employed by the system 102 of the present disclosure to render an indication of the status or health of the pump 100.

At function block 212, the process 200 further proceeds to identifying the location and/or amplitude of failure, for example, a location of leak and the amplitude of the leak in the pump 100. Additionally, at function block 212, the process 200 may also include suggesting to an operator of the pump 100, corrective actions to prevent or reverse the failure event. At function block 214, the process 200 may include outputting the service life of the pump 100 before complete shutdown or failure occurs.

In various embodiments of the present disclosure, it is envisioned that various other types of data pertaining to the power source 104 and the pump may be additionally collected at the DAE 124. This data may include, for example, indicated power of an engine, theoretical fluid flow from the pump 100, and/or discharge pressure of the pump 100 when the pump 100 operates under healthy conditions. In one example, the theoretical fluid flow data of the pump 100 may be multiplied with the discharge pressure data of the pump to give a theoretical fluid power from the pump 100. Moreover, loss information i.e., information which may be a function of operating speed, fluid temperatures, transmission gear, and the like may be deducted from the indicated power of the engine to result in a supposed power output of the pump 100. If the theoretical fluid power is higher than the supposed power output of the pump 100, it can be an indication that the pump 100 is not pressurizing the theoretical amount of fluid. The higher theoretical fluid power of the pump 100 could further indicate that cavitation has occurred in partially filled cylinders 110 of the pump 100.

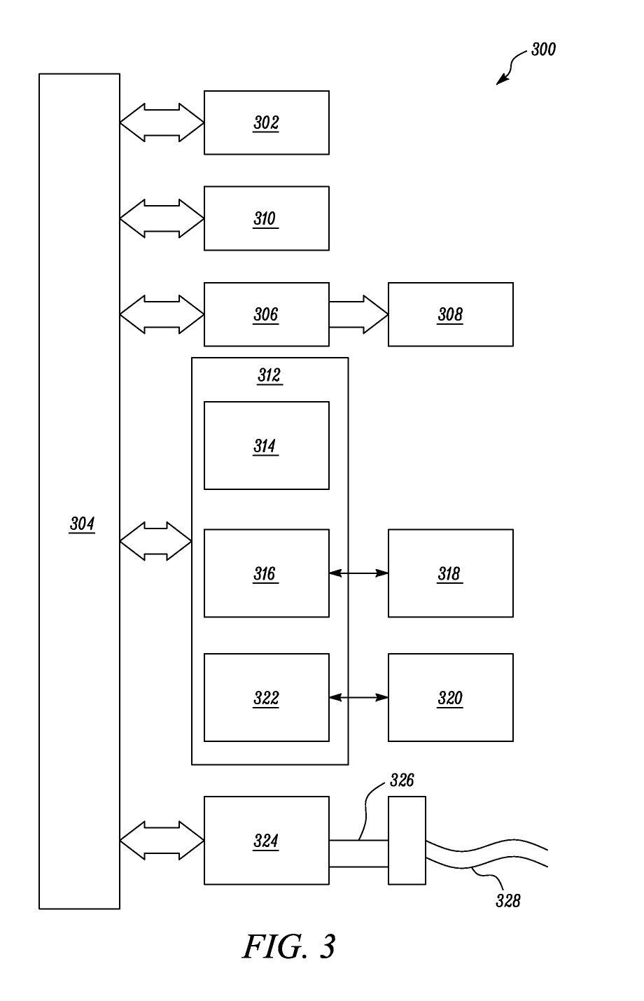

In accordance with an embodiment of the present disclosure, the present disclosure is directed towards one or more computer systems capable of carrying out the functionality described herein. An example of the computer based system includes a computer system 300, which is shown by way of a block diagram in FIG. 3.

Computer system 300 includes at least one processor, such as a processor 302. Processor 302 may be connected to a communication infrastructure 304, for example, a communications bus, a cross-over bar, a network, and the like. Various software embodiments are described in terms of this exemplary computer system 300. Upon perusal of the present description, it will become apparent to a person skilled in the relevant art(s) how to implement the present disclosure using other computer systems and/or architectures.

Computer system 300 includes a display interface 306 that forwards graphics, text, and other data from communication infrastructure 304 (or from a frame buffer) for display on a display unit 308.

Computer system 300 further includes a main memory 310, such as random access memory (RAM), and may also include a secondary memory 312. Secondary memory 312 may further include, for example, a hard disk drive 314 and/or a removable storage drive 316, representing a floppy disk drive, a magnetic tape drive, an optical disk drive, etc. Removable storage drive 316 reads from and/or writes to a removable storage unit 318 in a well known manner. Removable storage unit 318 may represent a floppy disk, magnetic tape or an optical disk, and may be read by and written to by removable storage drive 316. As will be appreciated, removable storage unit 318 includes a computer usable storage medium having stored therein, computer software and/or data.

In accordance with various embodiments of the present disclosure, secondary memory 312 may include other similar devices for allowing computer programs or other instructions to be loaded into computer system 300. Such devices may include, for example, a removable storage unit 320, and an interface 322. Examples of such may include a program cartridge and cartridge interface (such as that found in video game devices), a removable memory chip (such as an erasable programmable read only memory (EPROM), or programmable read only memory (PROM)) and associated socket, and other removable storage units 320 and interfaces 322, which allow software and data to be transferred from removable storage unit 320 to computer system 300.

Computer system 300 may further include a communication interface 324. Communication interface 324 allows software and data to be transferred between computer system 300 and external devices. Examples of communication interface 324 include, but may not be limited to a modem, a network interface (such as an Ethernet card), a communications port, a Personal Computer Memory Card International Association (PCMCIA) slot and card, and the like. Software and data transferred via communication interface 324 may be in the form of a plurality of signals, hereinafter referred to as signals 326, which may be electronic, electromagnetic, optical or other signals capable of being received by communication interface 324. Signals 326 may be provided to communication interface 324 via a communication path (e.g., channel) 328. Communication path 328 carries signals 326 and may be implemented using wire or cable, fiber optics, a telephone line, a cellular link, a radio frequency (RF) link and other communication channels.

In this document, the terms “storage medium” is used to generally refer to media such as removable storage drive 316, a hard disk installed in hard disk drive 314, signals 326, and the like. These computer program products provide software to computer system 300. The present disclosure is hereby also directed to such computer program products.

Computer programs (also referred to as computer control logic) may be stored in the main memory 310 and/or the secondary memory 312. Computer programs may also be received via the communication interface 304. Such computer programs, when executed, enable computer system 300 to perform the functions consistent with the present disclosure, as discussed herein. In particular, the computer programs, when executed, enable processor 302 to perform the features of the present disclosure.

In accordance with an embodiment of the present disclosure, where the disclosure is implemented using a software, the software may be stored in a computer program product and loaded into computer system 300 using removable storage drive 316, hard disk drive 314 or communication interface 324. The control logic (software), when executed by processor 302, causes processor 302 to perform the functions of the present disclosure as described herein.

In another embodiment, the present disclosure is implemented primarily in hardware using, for example, hardware components such as application specific integrated circuits (ASIC) Implementation of the hardware state machine so as to perform the functions described herein will be apparent to persons skilled in the relevant art(s).

Various embodiments disclosed herein are to be taken in the illustrative and explanatory sense, and should in no way be construed as limiting of the present disclosure. All joinder references e.g., attached, affixed, coupled, engaged, connected, and the like are only used to aid the reader's understanding of the present disclosure, and may not create limitations, particularly as to the position, orientation, or use of the systems, processes, and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

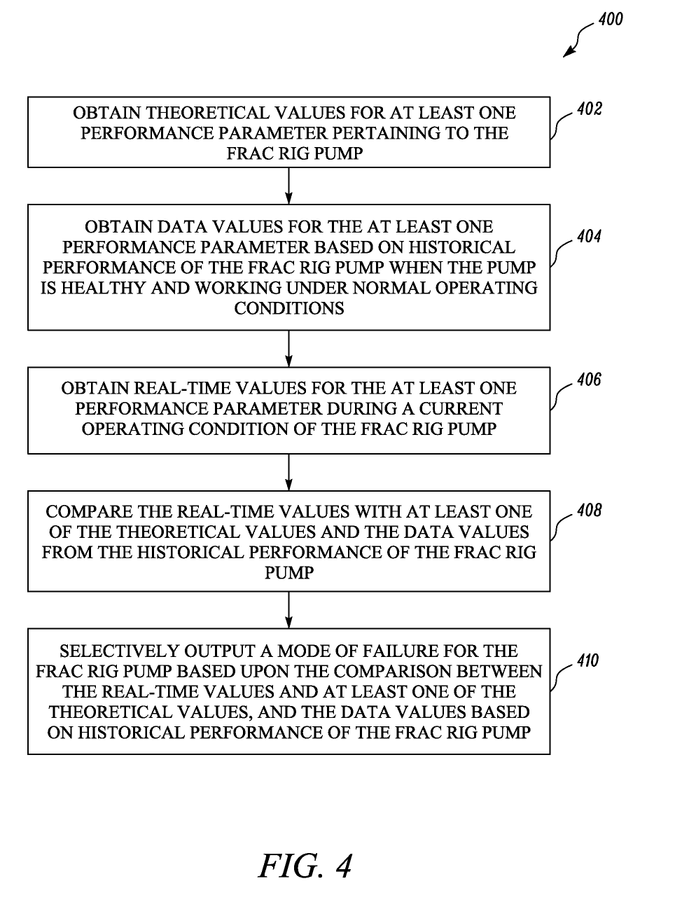

FIG. 4 illustrates a method 400 for monitoring health of the pump 100, in accordance with an embodiment of the present disclosure. At step 402, the method 400 includes obtaining theoretical values for at least one performance parameter pertaining to the pump 100. At step 404, the method 400 further includes obtaining data values for the at least one performance parameter based on historical performance of the pump 100 when the pump is healthy and working under normal operating conditions. At step 406, the method 400 further includes obtaining real-time values for the at least one performance parameter during a current operating condition of the pump 100.

At step 408, the method 400 further includes comparing the real-time values with at least one of the theoretical values and the data values from the historical performance of the pump 100. At step 410, the method 400 further includes selectively outputting a mode of failure for the pump 100 based upon the comparison between the real-time values and at least one of the theoretical values, and the data values based on historical performance of the pump 100.

In methodologies directly or indirectly set forth herein, various steps and operations are described in one possible order of operation, but those skilled in the art will recognize that steps and operations may be re-arranged, replaced, or eliminated without departing from the spirit and scope of the present disclosure as set forth in the claims.

Embodiments of the present disclosure have applicability for use and implementation in monitoring a health and performance of a pump. Typically, components of a pump are subject to high working pressures during operation. Consequently, a frequency of failure and subsequent maintenance of the components in a given pump may be high.

With implementation of the diagnosis and prognosis system 102 disclosed herein, operators of pumps may be alerted of a possible failure of a component in the pump beforehand. With early indication of a possible failure, operators of a given pump may conveniently plan to perform shutdown, replacement, maintenance, overhaul, and/or other service routines on the pump in a timely manner with little or no obstruction to an ongoing procedure in a jobsite, i.e., a wellbore. Moreover, upon detection of a possible failure by the system 102, operators may conveniently perform the necessary actions as the system 102 is configured to additionally provide a manner of taking corrective actions to prevent i.e., perform prognosis, or diagnose the failure. Furthermore, with use of the system 102 disclosed herein, time and effort previously incurred with maintenance of pumps may be offset thus saving costs to operators of pumps.

While aspects of the present disclosure have been particularly shown and described with reference to the embodiments above, it will be understood by those skilled in the art that various additional embodiments may be contemplated by the modification of the disclosed machines, systems, processes, and methods without departing from the spirit and scope of what is disclosed. Such embodiments should be understood to fall within the scope of the present disclosure as determined based upon the claims and any equivalents thereof.

What is claimed is:

1. A prognosis and diagnosis system for a pump, the system comprising:
a reference dataset comprising theoretical values obtained for at least one performance parameter pertaining to the pump;
a historical dataset comprising data values for the at least one performance parameter based on historical performance of the pump, the data values obtained from the frac rig pump under healthy and normal operating conditions of the pump;
a data acquisition engine configured to obtain real-time values for the at least one performance parameter, the real-time values measured during a current operating condition of the pump; and
a comparison engine in communication with the reference dataset, the historical dataset, and the data acquisition engine, the comparison engine configured to selectively output a mode of failure based upon a comparison between the real-time values and at least one of the theoretical values from the reference dataset and the data values from the historical dataset.

2. The prognosis and diagnosis system of claim 1, wherein the theoretical values are empirically calculated values of the at least one performance parameter pertaining to the pump.

3. The prognosis and diagnosis system of claim 1, wherein the at least one performance parameter includes at least one of torque of the pump, in-cylinder pressure of the pump, and manifold pressure associated with the pump.

4. The prognosis and diagnosis system of claim 1, wherein the comparison engine is further configured to determine service life before failure of the pump.

5. The prognosis and diagnosis system of claim 4 further comprising a display device disposed in communication with the comparison engine, the display device configured to display the mode of failure, and the service life remaining before failure of the pump.

6. The prognosis and diagnosis system of claim 1 further comprising a controller disposed in communication with the comparison engine, the controller configured to modulate the operation of the pump based on the comparison between the real-time values with at least one of the theoretical values from the reference dataset and the data values from the historical dataset.

7. The prognosis and diagnosis system of claim 1, wherein the reference dataset and the historical dataset are implemented on a memory device.

8. A method for monitoring health of a pump, the method comprising:
obtaining theoretical values for at least one performance parameter pertaining to the pump;
obtaining data values for the at least one performance parameter based on historical performance of the pump when the pump is healthy and working under normal operating conditions;
obtaining real-time values for the at least one performance parameter during a current operating condition of the pump;
comparing the real-time values with at least one of the theoretical values and the data values from the historical performance of the pump; and
selectively outputting a mode of failure for the pump based upon the comparison between the real-time values and at least one of the theoretical values, and the data values based on historical performance of the pump.

9. The method of claim 8, wherein the theoretical values are empirically calculated values for the at least one performance parameter pertaining to the pump.

10. The method of claim 8, wherein the at least one performance parameter includes at least one of torque of the pump, in-cylinder pressure of the pump, and manifold pressure associated with the pump.

11. The method of claim 8 further comprising determining a service life of the pump before failure.

12. The method of claim 11 further comprising displaying the mode of failure for the pump, and the service life remaining before failure of the pump on a display device.

13. The method of claim 8 further comprising modulating an operation of the pump based on the comparison between the real-time values and at least one of the theoretical values, and the data values associated with historical performance of the pump.

14. The method of claim 8 further comprising recursively storing the data values associated with the historical performance of the pump on a memory device.

15. A non-transitory computer-readable medium having stored thereon sequences of instruction, the sequences of instruction including instruction which when executed by a computer-based system for monitoring health of a pump, causes the computer-based system to perform operations, comprising:
obtaining, by the computer based system, theoretical values for at least one performance parameter pertaining to the pump;
obtaining, by the computer based system, data values for the at least one performance parameter based on historical performance of the pump when the pump is healthy and working under normal operating conditions;
obtaining, by the computer based system, real-time values for the at least one performance parameter during a current operating condition of the pump; and
comparing, by the computer based system, the real-time values with at least one of the theoretical values and the data values from the historical performance of the pump; and
selectively outputting, by the computer based system, a mode of failure for the pump based upon the comparison between the real-time values and at least one of the theoretical values, and the data values based on historical performance of the pump.
